(19) United States
(12) Patent Application Publication
(10) Pub. No.: US 2019/0244228 A1
(43) Pub. Date: Aug. 8, 2019

(54) Survey Data Verification Systems and Methods

(71) Applicant: Christopher Michael Turner, Alexandria, VA (US)

(72) Inventor: Christopher Michael Turner, Alexandria, VA (US)

(21) Appl. No.: 16/237,428

(22) Filed: Dec. 31, 2018

Related U.S. Application Data
(60) Provisional application No. 62/613,707, filed on Jan. 4, 2018.

(51) Int. Cl. G06Q 30/02

(52) U.S. Cl. CPC G06Q 30/0203; G06Q 30/0205

(57) ABSTRACT

In some embodiments, a system may be configured to process survey results together with associated location and timing information to automatically determine the reliability of the survey data. In certain embodiments, the system may be configured to receive captured data including survey responses and at least one of timing data, location data, keystroke data, and audio data. The system may be further configured to automatically determine a reliability score associated with each of the survey responses from the captured data. In some embodiments, the system may be configured to identify fake or false survey data or reliable survey data based on the reliability score.

### CROSS-REFERENCE TO RELATED APPLICATION(S)

The present disclosure is a non-provisional of and claims priority to U.S. Provisional Patent Application No. 62/613,707 filed on Jan. 4, 2018 and entitled “Survey Data Verification Systems and Methods”, which is incorporated herein by reference in its entirety and for all purposes.

### FIELD

The present disclosure is generally related to determine reliability of survey data, and more particularly to devices, systems, and methods of determining reliability of survey data based on timing, geo-location, and other information. In some instances, such devices, systems, and methods may include automatically valuing such data based on the reliability and selectively adjusting a user's pay based on the determined reliability of the data.

### BACKGROUND

Surveys have long been used to capture information regarding public opinion. For example, businesses may initiate surveys to gather information and may use the survey information to determine their strengths and weaknesses in the consumer marketplace. In another example, political campaigns may commission surveys to determine voter preferences and to determine a candidate's strengths and weaknesses in the political marketplace.

Generally, techniques for soliciting and capturing such information have improved over the years. Additionally, data collection processes have evolved from paper collection of canvasser data and manual tabulation of responses to mailed surveys to electronic collection and tabulation. In recent years, the proliferation of communications media and communication devices have greatly expanded the opportunities and ways by which such information can be captured and collected in real time.

### SUMMARY

Embodiments of systems, methods, and devices are described below that may be configured to receive data from one or more electronic devices through a network and to automatically determine reliability of survey responses within the received data. The data may include survey responses, identifier information, location information, timing data, and other data. The systems, methods, and devices may be configured to process the survey responses together with the other data to detect timing, location, and other indicia of reliability and to automatically determine reliability associated with each survey of the survey data based on the received data. In some embodiments, unreliable data may be discarded from survey responses. Further, in some instances, wages for a canvasser responsible for submitting the unreliable data may be docked or otherwise adjusted. Other embodiments are also possible.

In some embodiments, a system may be configured to process survey results together with associated location and timing information to automatically determine the reliability of the survey data. In certain embodiments, the system may be configured to identify fake or false survey data, which may be fabricated and entered by a canvasser in order to maximize his or her wages, for example, in a situation where the canvasser's pay is based on the number of completed surveys. The system may identify the fake or false survey data based, at least in part, on correlations between the survey responses and the location and timing associated with the collection of the survey data. In some aspects, the system may be configured to discard, label, or otherwise identify fake or false survey data to prevent such data from influencing the survey results. In some embodiments, the system may be configured to generate a report that can be sent through a computing network, such as the Internet, to a computing device associated with an administrator or to another computing system. In some instances, in response to identification of false or otherwise unreliable survey data, the system may be configured to reduce the canvasser's compensation.

In some embodiments, a computing device can include an interface configured to couple to a network, a processor coupled to the interface, and a memory accessible to the processor. The memory may be configured to store instructions that, when executed, cause the processor to receive data including survey responses, timing data, and location data. The instructions further may cause the processor to automatically determine a reliability score associated with each of the survey responses from the data based at least on the timing data and the location data and optionally based on the type of survey (e.g., in person or telephonic). The memory may also include instructions that can cause the processor to provide a report indicating survey results, reliability data, other data, or any combination thereof via the network to a computing device associated with an administrator or another system. In some embodiments, the report may include survey results selectively determined from the survey response data based on the reliability scores from each of the survey responses.

In some aspects, the memory may include instructions that, when executed, may cause the processor to correlate the timing data and the location data to each survey response. The instructions further may cause the processor to determine a time difference between capture of a first survey response at a first location and capture of a second survey response at a second location based on the timing data. Additionally, the instructions can cause the processor to determine an estimated travel time between a first location associated with a first survey response and a second location associated with a second survey response. The instructions may cause the processor to determine reliability of the survey responses based on a comparison on the time difference to the estimated travel time.

In some embodiments, a method may include receiving first survey data associated with a first respondent at a first location and a first time and receiving second survey data associated with a second respondent a second location and a second time. The method may further include determining an estimated travel time between the first location and the second location and a time difference between the first time and the second time. The method may also include identifying the second survey data as being unreliable based on a comparison of the time difference to the estimated travel time. In an example, if the time difference is significantly less than the estimated travel time, the second survey data may be labeled as unreliable. The method may further include labeling the second survey data with a reliability score indicating that the second survey data is unreliable or is less reliable that first survey data. Other embodiments are also possible.

In some embodiments, a system may be configured to receive survey data from a plurality of computing devices, where each computing device is associated (such as by login information) with a particular user (canvasser). The system may be configured to process the survey data to determine reliability of the survey data based on associated location and timing information. Further, the system may be configured to communicate the survey results and a reliability indicator to at least one of a computing device associated with an administrator and another computing system. Further, the system may be configured to update a human resources system based on the reliability indicator.

In some embodiments, a computing device may include display, a global positioning satellite (GPS) circuit, a network interface configured to communicate with a communications network, and a memory, each of which may be accessible to a processor. The memory may store instructions that, when executed, can cause the processor to provide an interface including survey questions and user-selectable elements to a display of the collection device to facilitate the conducting of a survey. The processor may receive input data corresponding to the survey and may correlate each input to location data from the GPS circuit and to timing data. The instructions further may cause the processor to forward input data together with timing data and location data to a computing system for further processing to determine reliability of the input data.

In other embodiments, a computing device may include an interface configured to couple to a network, a processor coupled to the interface, and a memory accessible to the processor. The memory may be configured to store instructions that, when executed, cause the processor to receive captured data including survey responses and associated data and automatically determine a reliability score associated with each of the survey responses from the survey responses and the associated data. The memory may further include instructions that, when executed, cause the processor to provide a report to a device via the network, the report including survey results selectively determined from the survey responses based on the reliability scores from each of the survey responses.

In still other embodiments, a system may include an interface configured to communicate with a communications network, a processor coupled to the interface, and a memory accessible to the processor. The memory may be configured to store instructions that, when executed, may cause the processor to receive survey data and associated captured data from a plurality of computing devices through the communications network. Each computing device may be associated with a particular canvasser. The memory may further include instructions that, when executed, cause the processor to process the survey data to determine reliability of the survey data based on the associated data and communicate survey results including a reliability indicator based on the determined reliability and the survey data.

In other embodiments, a method may include receiving, at a server through a network, first survey data and first associated data from a computing device. The method may further include receiving, at the server through the network, second survey data and second associated data from the computing device. Further, the method may include automatically determining a first reliability value associated with the first survey data based on the first associated data and automatically determining a second reliability value associated with the second survey data based on the second associated data. The method may also include automatically generating a report including data related to the first survey data and the second survey data and including the first reliability value and the second reliability value and sending the report from the server to a device through a network.

In yet other embodiments, a system may include an interface configured to communicate with a communications network, a processor coupled to the interface, and a memory accessible to the processor. The memory may be configured to store instructions that, when executed, may cause the processor to receive survey data and associated data from a plurality of computing devices through the communications network. Each computing device may be associated with a particular canvasser. The memory may further include instructions that, when executed, may cause the processor to process the survey data to determine reliability of the survey data based on the associated captured data and communicate survey results including a reliability indicator based on the determined reliability and the survey data to a device through the communications network.

### BRIEF DESCRIPTION OF THE DRAWINGS

FIG. 1 depicts a block diagram of a system configured to determine reliability of survey data, in accordance with certain embodiments of the present disclosure.

FIG. 2 depicts a block diagram of a system configured to determine reliability of survey data and including a human resources system, in accordance with certain embodiments of the present disclosure.

FIG. 3 depicts a block diagram of a method of using reliability data to determine wages of a canvasser, in accordance with certain embodiments of the present disclosure.

FIG. 4 depicts a block diagram of a method of generating a report based on survey data and including a reliability indicator, in accordance with certain embodiments of the present disclosure.

FIG. 5 depicts a block diagram of a method of determining a reliability score for survey data based on audio data of a canvasser's survey questions, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

For entities (individuals, companies, campaigns, or others) requesting survey data and canvassers contracted to acquire such data, there has always been concern about the quality, reliability, truthfulness, and proper segmentation of the respondents. Moreover, data reliability also can be dependent on the canvasser, i.e., the person conducting the survey. Embodiments of systems, devices, and methods described below may be configured to automatically determine reliability of survey data. In some embodiments, a system may receive data including survey responses from a computing device associated with a canvasser and may automatically determine reliability of the survey responses based on the data, whether the data is collected through in-person, face-to-face, question/answer encounters, through Internet-based surveys, or over the phone.

In the following detailed description of embodiments, reference is made to the accompanying drawings which form a part hereof, and which are shown by way of illustrations. It should be understood that features of various described embodiments may be combined, other embodiments may be utilized, and structural changes may be made without departing from the scope of the present disclosure. It should also be understood that features of the various embodiments and examples herein can be combined, exchanged, or removed without departing from the scope of the present disclosure.

In accordance with various embodiments, the methods and functions described herein may be implemented as one or more software programs running on a computer processor or controller. In accordance with various embodiments, the methods and functions described herein may be implemented as one or more software programs running on a computing device, such as a tablet computer, smartphone, laptop computer, personal computer, server, or any other computing device. Dedicated hardware implementations including, but not limited to, application specific integrated circuits, programmable logic arrays, and other hardware devices can likewise be constructed to implement the methods and functions described herein. Further, the methods described herein may be implemented as a device, such as a computer readable storage medium or memory device, including instructions that when executed cause a processor to perform the methods. Other embodiments may also be possible.

Embodiments of systems, methods, and devices are described below that can be used to conduct a survey, record the survey data, and infer the reliability of the survey data (from the data collection perspective) based on timing data, recorded data, location data, other data, or any combination thereof. In a particular embodiment, a device may be a portable computing device (such as a smart phone, a tablet computer, a laptop computer, another computing device, or any combination thereof) that can be configured to provide survey questions and user-selectable elements accessible by a user to input response data corresponding to the respondent's answers to the survey questions. The response data may be correlated to timing data, recorded data, location data, other data, or any combination thereof. The correlated response data may be used as a basis for evaluating the reliability of the response data.

In some embodiments, the device may provide a route to be traversed by the user in conducting the survey, which route may include particular addresses to visit, and so on. In certain embodiments, the location data and timing data may be used to determine a reliability score for particular survey results. For example, an estimated time required to travel from a first location to a second location on the route to be traversed may be compared against actual timing data related to the collection of first data associated with a first address and second data associated with a second address on the route to verify that the survey data was actually collected from real respondents to be surveyed and not fabricated by the user.

In the context of a telephonic interview, the device may correlate timing data associated with the phone call with response data to determine whether the timing of data entered corresponds to the expected timing for asking questions from the survey and receiving answers from a user. Further, audio data may be processed to verify whether the canvasser is asking the survey questions. Fast data entry, for example, may indicate that the responses are not actual survey responses but are actually fabricated responses. Alternatively, the user may record responses on a note pad and may enter the responses later. Accordingly, the duration of the call from a call log and analytics applied to the audio data from the canvasser's portion of the telephone survey may be applied to determine whether the survey questions were asked and may be used to confirm whether the survey was conducted and to infer the reliability of the respondent's answers.

In some embodiments, the device may include a global positioning satellite (GPS) circuit, a network interface configured to couple to a communications network (such as the Internet), and a memory (such as a flash memory device, a hard disc drive, a cache memory device, or any combination thereof), each of which may be coupled to a processor. The memory may include instructions that, when executed, may cause the processor to provide a graphical interface including address data, survey questions, and user-selectable elements to a display of the data collection device to facilitate the conducting of a survey. In some embodiments, the display may be a touchscreen configured to display data and to receive input data. In response to providing the graphical interface, the processor may receive input data including answers to the survey questions (survey results) and may forward input data together with timing data and location data to a computing system for further processing to determine reliability of the received survey data.

In some embodiments, a system may be configured to push one or more graphical interfaces including survey questions and survey route information to one or more devices through a communications network. In this example, the system may include a content server and a survey response data processing server. The system may be configured to push different survey questions, different survey route information, other data, or any combination thereof to the one or more devices. In one possible example, each device may have the same survey questions and different survey route information so that the survey may be executed by multiple users to canvas an area.

In response to pushing the graphical interface, the system may receive survey data from one or more computing devices through a communications network. Each computing device may be associated with a particular user (canvasser) such as by login information. The system may be configured to process the survey data to determine reliability of the survey data based on timing data, recorded data, location data, other data, or any combination thereof. The system may be further configured to store the survey results and one or more associated reliability indicators in a database. Additionally, the system may be configured to generate a report including the survey results, reliability indicator data, other data, or any combination thereof to an operator.

In some embodiments, the system may be configured to update a human resources system based on the survey data and the associated reliability indicator. For example, when survey results are determined to be unreliable, the system may provide data related to the survey data and the associated reliability indicator to the human resources system, which may determine or otherwise adjust compensation for the user (canvasser) based on the survey data and the associated reliability indicator. In an example where the survey data is entirely unreliable (such as where the GPS location data correlated with the survey data does not match the route data provided with the survey), the reliability indicator may be used to withhold payment for “fraudulent” or “erroneous” services rendered by the user (canvasser). Further, the “reliability” of the data may be used, by the human resources system, to reward those users who accurately perform the survey and record the survey data. In an example, canvasser's who consistently perform well may be rewarded with increased pay, bonuses, and other rewards. Other embodiments are also possible.

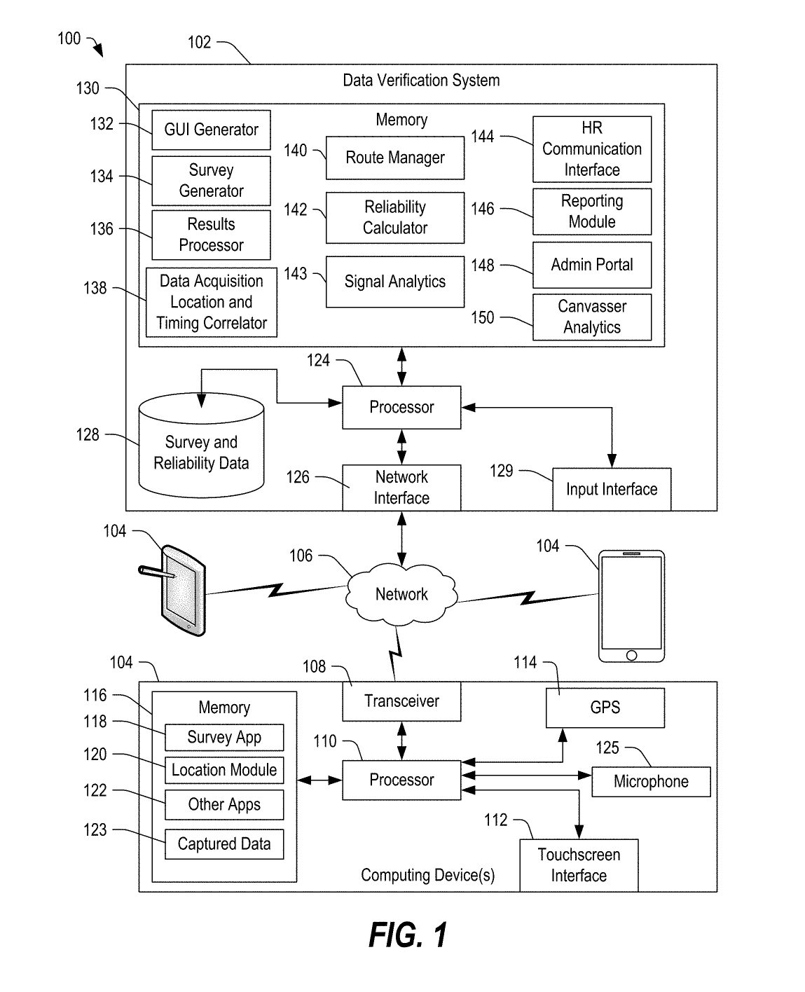

In the following discussion, reference may be made to computing devices. As used herein, the term “computing device” refers to an electronic device that is capable of receiving input data, processing data, executing instructions, and communicating with one or more other electronic devices through a network. Computing devices can include smartphones, tablet computers, laptop computers, desktop computers, computer servers, and other data processing devices capable of executing instructions stored in memory and capable of communicating data through a network. Further, in the following discussion, the term “system” refers to one or more computing devices configured to perform one or more operations, alone or in combination with other computing devices. One possible embodiment of a system including computing devices and that can be configured to determine reliability of survey response data is described below with respect to FIG. 1.

FIG. 1 depicts a block diagram of a system 100 configured to determine reliability of survey data, in accordance with certain embodiments of the present disclosure. The system 100 may include a data verification system 102 and may further include one or more computing devices 104 configured to communicate with the data verification system 102 through a communications network 106, such as the Internet. The computing devices may include one or more tablet computers, laptop computers, smartphones, other computing devices, or any combination thereof. Other embodiments are also possible.

The computing device 104 may include a transceiver 108 configured to communicate with the data verification system 102 through the network 106. The computing device 104 may further include a processor 110 coupled to the transceiver 108 and may include a touchscreen interface 112 coupled to the processor 110. Further, the processor 110 may be coupled to a global positioning satellite (GPS) circuit 114 configured to determine location information (GPS data). The processor 110 may also be coupled to a microphone 125 configured to capture audio data associated with a canvasser's portion of a survey (in person or over the phone). It should be appreciated that computing devices 104 typically include a speaker or audio interface (not shown). Additionally, the computing device 104 may include a memory 116 configured to store data and processor-executable instructions. While the computing device 104 is described as including a touchscreen interface 112, in some embodiments, the computing device 104 may include display and a keyboard separate from the display, which together may form an input interface.

The memory 116 may include a survey application 118 that, when executed, may cause the processor 110 to produce a graphical interface including route or address information of locations to conduct a survey (or alternatively phone numbers of respondents to contact), prompts (such as survey questions), and user-selectable elements (such as checkboxes, radio buttons, text fields, pulldown menus, and other selectable input elements) accessible by the canvasser to enter the survey response data.

The processor 110 may present the graphical interface to the touchscreen interface 112. The user (canvasser) may interact with the touchscreen interface 112 or other input interface to input data (survey responses) to the prompts via the user-selectable elements. In one possible example, the canvasser may read survey questions aloud from the graphical interface displayed on the touchscreen interface 112. The memory 116 may further include a location module 120 that, when executed, may cause the processor 110 determine the geophysical location of the computing device 104 at the time when the survey data is entered by the user based on signals from the GPS circuit 114 and to associate (correlate) the location data and the time data with the survey data.

In some embodiments, the memory 116 may include other applications 122 that may be executed by the processor 110 to perform various operations, such as text messaging, establishing phone calls, capturing and storing call log data, recording survey calls, performing other operations, and so on. Captured data 123 may be stored in memory 116. The captured data 123 can include captured keystroke data, audio data associated with the canvasser, time data, GPS location data, other data, or any combination thereof. In some embodiments, the computing device 104 may be configured to transmit the survey data and the associated location data and timing data (captured data 123) to the data verification system 102 through the network 106. The captured data 123 may be transmitted in real time as the user enters the data, at the completion of a survey, periodically, at scheduled times, when the user closes the survey application 118, or any combination thereof.

In some embodiments, the survey application 118 may cause the processor 110 to capture audio data associated with the canvasser and to store the audio data as captured data 123 together with the survey responses. The captured data 123 and survey responses may be sent to the data verification system 102. In some embodiments, the survey application 118 may cause the processor 110 to track keystrokes, timing between keystrokes, and other user interactions with a graphical interface, which interactions may include entering responses to the survey questions. The keystroke data may be provided to the data verification system 102, which may be configured to process the keystroke data to verify the authenticity of the survey responses. In an example, it takes time to read and process questions and to respond and, if the data entry time is too short to allow the questions to be read, the response data may be unreliable.

The data verification system 102 may include a network interface 126 that may be configured to communicate with the network 106 to send and receive data. The data verification system 102 can include a processor 124 coupled to the network interface 126 and to a data file or database 128 including survey and reliability data 128. The processor 124 may also be coupled to an input interface 129 and to a memory 130. In some embodiments, the input interface 129 may include a keyboard interface, a touchscreen display, another input interface (such as a Universal Serial Bus (USB) port) that can be coupled to an external device by a USB cable, another interface, or any combination thereof.

The memory 130 can include instructions that, when executed, may cause the processor 124 to perform a variety of functions. In some embodiments, the memory 130 may include a graphical user interface (GUI) generator 132 that, when executed, may cause the processor 124 to generate a graphical interface, which can be presented as a web page (that can be rendered within an Internet browser application of a computing device 104). The graphical interface may include survey prompts and user-selectable elements, such as checkboxes, radio buttons, pulldown menus, tabs, text fields, other objects, or any combination thereof.

The memory 130 may also include a survey generator 134 that, when executed, may cause the processor 124 to generate survey prompts (such as questions) and associated user-selectable elements, which can be provided within the graphical interface produced by the GUI generator 132. The memory 130 can also include a results processor 136 that, when executed, may cause the processor 124 to receive the survey data and to store the survey data in one or more tables (or in the database 128). In some embodiments, the survey data may include responses to the survey prompts from respondents.

The memory 130 may further include a data acquisition location and timing correlator 138 that, when executed, may cause the processor 124 to correlate the location and timing data to the survey data. In a particular example, the timing and location data may be correlated to each response within a survey. In some embodiments, the data acquisition location and timing correlator 138 may cause the processor 124 to correlate call log data and timing data to the survey data (e.g., the captured data 123), such as when the survey is conducted via a telephone call. Alternatively, the data acquisition and timing correlator 138 may cause the processor 124 to correlate audio data from a call-based survey to the location and timing data to verify timing to ensure that survey questions were asked and answered. In some examples, the processor 124 may be configured to perform speech-to-text conversion of the audio from the call and to compare the text to the survey to verify that the questions were asked. Other embodiments are also possible.

The memory 130 may further include a route manager 140 that, when executed, may cause the processor 124 to determine a set of locations (addresses) for the user to visit to conduct the survey. In some embodiments, the route manager 140 may cause the processor 124 to present the set of locations in a “route order” within the graphical interface. The “route order” may include an efficient ordering of the addresses or locations for completion of the survey. One possible route order may be a postal carrier route that is a group of addresses (e.g., neighborhoods) that can be grouped to provide, for example, mail delivery efficiency. In some embodiments, the route manager 140 may determine estimated travel times for the user to travel between each of the locations or addresses along the route.

The memory 130 can include a reliability calculator 142 that, when executed, may cause the processor 124 to determine a reliability score for each survey response based in part on the timing and location data associated with the survey responses. In an example, the survey or canvass may be scheduled for particular addresses or locations. The reliability calculator 142 may cause the processor 124 to receive survey data and to compare the correlated location and timing data associated with the survey data to verify that the survey was conducted at the scheduled addresses along the route based on the location data. Further, the amount of time between surveys and between survey responses may be evaluated against the estimated travel time to determine if the timing corresponds to a real survey response or a fake survey response (e.g., a response entered by the user without actually surveying a person may be entered much more quickly than if the canvasser asked the question and waited for a response). Further, the reliability calculator 142 may cause the processor 124 to take into account other considerations as well, such as the length of the survey, the time it takes to conduct complete the survey, and so on. For example, when the time between recorded answers or the overall survey time falls outside of a pre-determined time range, the reliability calculator 142 may cause the processor 124 to determine a reliability score that reflects that the survey data is unreliable. Other embodiments are also possible.

The memory 130 may further include signal analytics 143 that, when executed, may cause the processor 124 to analyze keystroke data from the survey application 118 or audio data from the canvasser's portion of the telephone call for a phone survey. The signal analytics 143 may cause the processor 124 to process keywords of a canvasser's portion of the survey conversation to verify whether the canvasser is asking the questions from the survey. In one possible aspect, the signal analytics 143 may include speech-to-text conversion, which can cause the processor 124 to convert the audio signal into text for comparison to the text of the survey questions. The reliability calculator 142 may cause the processor 124 to determine a reliability score for each response and for the survey responses of a given interviewee, at least in part, based on the keystroke data or the audio data. Other embodiments are also possible.

In some embodiments, such as when the survey as is a telephone survey, the reliability calculator 142 may determine the reliability score based on call log data, the timing of the survey responses, a comparison of words extracted from the audio data and keyword associated with the survey, other information, or any combination thereof. Other embodiments are also possible.

In some embodiments, when the comparison between the address data and the GPS location data shows discrepancies (such as the user did not visit the address), the reliability calculator 142 may cause the processor 124 to assign a low reliability score to the survey data. Further, in some embodiments, when the GPS data and the timing data indicate that the user did not stay at the address long enough to conduct the survey (e.g., time at the location is less than a survey timing threshold), the reliability calculator 142 may cause the processor 124 to assign a low reliability score to the survey data. On the other hand, if the comparison shows that the location matches the GPS data and the amount of time spent at the location is greater than the survey timing threshold, the reliability calculator 142 may cause the processor 124 to assign a high reliability score to the survey response data.

Further, the reliability calculator 142 may evaluate the amount of time the canvasser was on a call with the respondent (based on call log data) and compare the amount of time to an estimated time for conducting the survey. A call that is too brief (according to a comparison of the call log to the estimated survey time) may indicate that the corresponding survey data is unreliable. Other bases for determining reliability based on the call data may also be used. For example, the key words extracted from captured audio data by the signal analytics 143 may be compared against the survey questions to verify if the survey questions are being asked.

In some embodiments, the reliability calculator 142 may also cause the processor 124 to evaluate the content of the survey responses to further evaluate the reliability of the survey responses. For example, the reliability calculator 142 may also cause the processor 124 to assign a low reliability score to survey responses that potentially indicate fraud, falsification, or duplication. Other embodiments are also possible.

In some embodiments, the reliability calculator 142 may determine invalid GPS survey data as compared to expected GPS data for the survey location (such as a residence for a particular survey candidate). The reliability calculator 142 may also determine inconsistent survey times as compared to average survey times of other canvassers (too fast or too slow). The reliability calculator 142 may also determine walking times that are inconsistent with average times of other canvassers (too fast or too slow). Other examples are also possible.

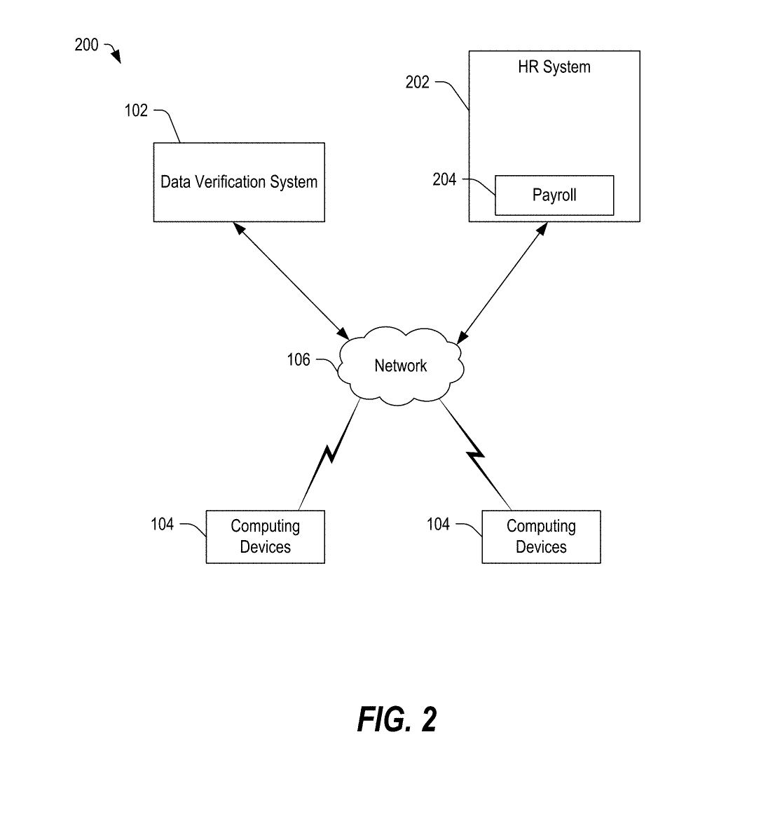

The memory 130 may include a human resources (HR) communication interface 144 that, when executed, may cause the processor 124 to interact with an HR system (such as the HR system 202 in FIG. 2). In a particular example, when the collected survey data is unreliable, the survey data may be labeled with a reliability factor indicating that the survey data is less than reliable. Further, the HR communication interface 144 may cause the processor 124 communicate data related to the reliability data to the HR system, so that payment to the data collector (the canvasser conducting the survey) may be adjusted to reflect the quality of the data, for example.

In some embodiments, the HR communications interface 144 may provide reliability data that can be used by an HR system to determine quality canvassers as compared to canvassers that underperform or that provide unreliable survey data. Operators of the HR system may then utilize wages, bonus, promotions, other opportunities, or any combination thereof to reward quality employees. Other embodiments are also possible.

Further, the memory 130 can include a reporting module 146 that, when executed, may cause the processor 124 to generate an email, a text, or a survey report based on the received survey data. The report may include statistics or other analytics or other information derived from the survey results. In some embodiments, the reporting module 146 may cause the processor 124 to use the reliability score either to eliminate responses that do not reach a threshold level of reliability, or to weight such responses lower than other higher, more reliable responses.

In certain embodiments, the memory 102 may also include an administrative (admin) portal 148 that, when executed, may cause the processor 124 to present a graphical interface including survey information and user-selectable elements accessible by a user to configure a survey, to define project specific parameters, to define verification parameters, to define other parameters, or any combination thereof. In an example, an operator may use the input interface 129 to access a graphical interface provided by the processor 124 executing the admin portal 148 to configure survey questions as well as define one or more parameters that subsequently can be used in conjunction with the reliability calculator 142 to evaluate the reliability of the survey responses. In a particular example, the one or more parameters may include a first length of time associated with a duration of a first survey and a second length of time associated with a duration of a second survey. The reliability calculator 142 may verify survey data based on the script length or time parameter. Other embodiments are also possible.

In some embodiments, the data verification system 102 may be configured to define a series of dimensions, which can be used to form an overall reliability score for a given set of survey responses. Each dimension may represent a particular domain about which the data verification system can determine and assign some level of confidence. For example, one dimension may include the survey respondent's identity including, for example, the survey respondent's gender, age, name, race, area of domicile, income range, political affiliation, other information, or any combination thereof. In some embodiments, the data verification system 102 may have a profile associated with each address that may include information known or previously provided about the user or received from another source.

Another possible dimension that can be used to determine the reliability can include the speed with which the survey respondent responds to a survey or parts of a survey. The system can track a mean or median speed with which others took the survey or answered particular questions, and can assign a reliability score based on whether the speed of the survey responses represents an outlier or is within the standard deviation of other responses. Survey responses that are too quick may indicate a user who is falsifying information, for example, to earn an incentive. Further, the data verification system 102 may process the survey results to detect “straight line” or “pattern” responses, which indicate that the user (or respondent) consistently picks the same response, for example, in a multiple-choice survey or picks according to a pattern (e.g., A, B, C, D, A, B, C, D, and so on). Other embodiments are also possible.

In some embodiments, the survey application 118 may be downloaded to the computing device 104 and may be used to log in to the data verification system 102 to establish an account. The survey application 118 can be used by a worker in the field to interview people (respondents) using survey questions provided within a graphical interface of the survey application 118 and to collect responses (by interacting with the touchscreen interface 112). The survey application 118 may then send the collected response data (survey data) including associated timing data and location data (from the GPS circuit 114) to the data verification system 102.

In some embodiments, the data verification system 102 may process the received data to evaluate the reliability for each of the survey responses based, at least in part, on the reliability data. The data verification system 102 may then assign a reliability score to the survey responses. The data verification system 102 may further generate reports based on the survey responses, which reports may discard unreliable survey responses or may weight survey responses based on their associated reliability scores. In some embodiments, the data verification system 102 may notify an HR system based on the reliability data collected by a particular user, so that the HR system can take the reliability into account while determining the pay due to the user.

In some embodiments, the memory 130 may include canvasser analytics 150 that, when executed, may cause the processor 124 to synthesize received data and identify trends for each canvasser. In an example, the canvasser analytics 150 may be configured to determine attempted surveys as opposed to successful outcomes (completed surveys) by identifying reported failure reasons, connection failures, partial responses, and so on. The canvasser analytics 150 may be configured to evaluate the start and stop times and the number of survey attempts to determine a survey rate in terms of the number of survey attempts per hour. The canvasser analytics 150 may assign a quality score to a particular canvasser based on the canvasser's speed, the reliability of the survey results captured by the canvasser, the GPS proximity to the house/dwelling/structure associated with the survey, and so on. Canvassers that consistently score well according to the canvasser analytics 150 may be rewarded, such as by payment of a bonus or an increase in the hourly wages of the canvasser. Other embodiments and other rewards are also possible. In some embodiments, the canvasser analytics 150 may also provide validated billable hours for each canvasser to the HR system for each pay period based on the determined validity of the survey results. Other embodiments are also possible.

In operation, the data verification system 102 may be configured to receive data from a plurality of computing devices, such as tablet computers, smartphones, and the like. The data may include survey response data, timing data, and location data. The data verification system 102 may process the received data to determine reliability scores for each of the survey responses within the received data based, at least in part, on the location and timing data. The data verification system 102 may determine survey results based on the received data and the reliability scores. Other embodiments are also possible.

As mentioned above, in some instances, the received data may be analyzed and provided to a human resources system for use in determining wage adjustments and to identify good and bad canvassers for future hiring decisions and for determining bonuses and future employment. One possible example of a human resources system is described below with respect to FIG. 2.

FIG. 2 depicts a block diagram of a system 200 including a human resources system 202 communicatively coupled to the data verification system 102 of FIG. 1, in accordance with certain embodiments of the present disclosure. The system 200 may further include computing devices 104 coupled to the data verification system 102 (and optionally the HR system 202) through a network 106, such as the Internet.

In the illustrated example, the HR system 202 may include a payroll system 204 that may be configured to determine payroll for each of the employees or contractors (users) that utilize the computing device 104 to conduct surveys on behalf of a client. In some embodiments, the payroll system 204 may be configured to pay contractors or users (canvassers) for performing the survey (e.g., interviewing respondents according to the survey questions, recording the responses, and so on). The payroll system 204 may be configured to determine an amount to pay for survey results based, at least in part, on the reliability of the survey data. Falsified data entries, incomplete surveys, straight-line or pattern responses, failure to ask the questions from a survey script, and other discrepancies may be detected, and the payment for that particular canvasser may be adjusted. If, for example, the GPS data indicates that the user did not visit the addresses on the survey to receive the survey results, the payroll system 204 may dock the user's pay accordingly. If analysis of the audio data indicates that the key words from the survey questions were not asked, the payroll system 204 may reduce the canvasser's pay accordingly. Other embodiments are also possible.

The system 200 may provide a number of advantages over conventional survey analytics. For example, the system 200 may incentivize the user to conduct the survey as requested by the client by providing rewards (payment or bonuses) for well-conducted surveys and data collection. Further, the system 200 may be configured to automatically adjust the pay of users that fail to conduct the survey as requested based on the reliability score provided by the data verification system 102. Additionally, the system 200 may utilize GPS location data in conjunction with the timing and the address information for conducting the survey to determine when the user actually visits the addresses and records responses from the resident. Other embodiments are also possible.

In a commercial setting, for example, the data verification system 102 may be configured to recognize that the GPS location corresponds to a shopping center or a mall, which would enable a large number of survey respondents with little movement, as compared to a survey that requires the user to walk from house to house within a neighborhood. The data verification system 102 may be configured to take such commercial settings into account when determining the reliability of a particular set of survey results. Other embodiments are also possible.

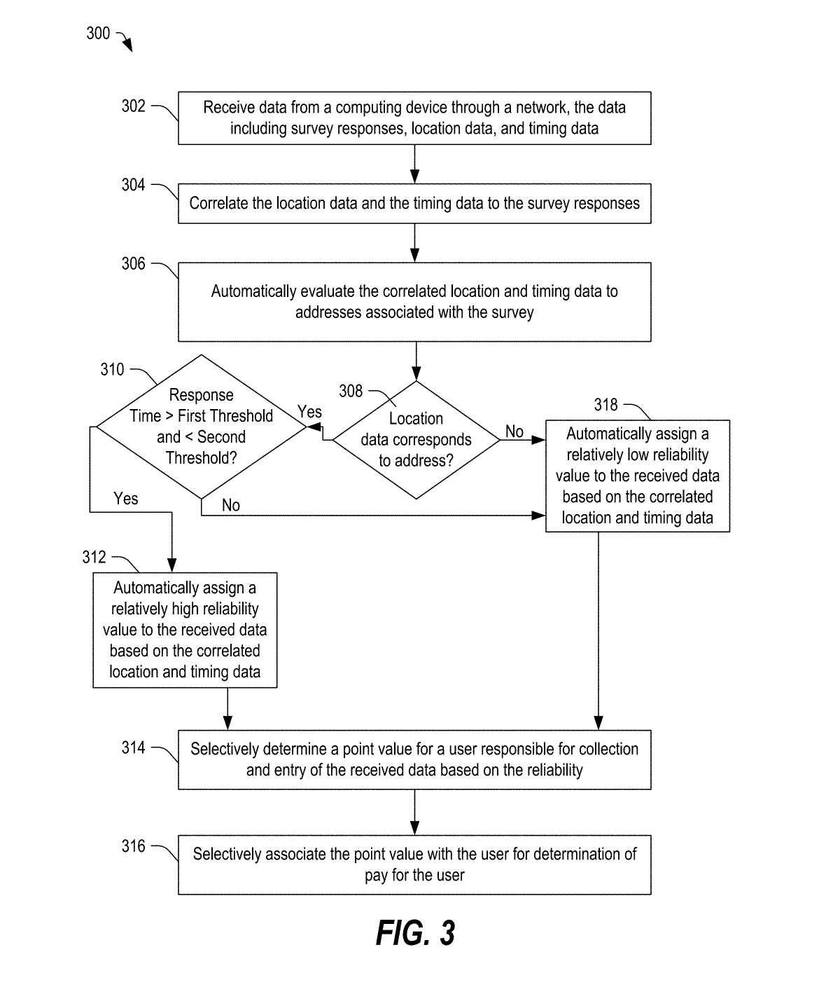

FIG. 3 depicts a block diagram of a method 300 of using reliability data to determine pay of a user inputting survey data (i.e., a canvasser), in accordance with certain embodiments of the present disclosure. At 302, the method 300 may include receiving data from a computing device through a network, where the data may include survey responses, location data (such as from a GPS circuit), and timing data. In a particular example, the computing device may include a GPS circuit that provides location data that is associated with the survey responses.

At 304, the method 300 can include correlating the location data and the timing data to the survey responses. In a particular example, each survey response may be associated with (correlated to) location and timing information.

At 306, the method 300 can include automatically evaluating the correlated location and timing data to addresses associated with the survey. In some embodiments, the survey may include a route including a plurality of addresses to be visited by the user to ask the survey questions of the residents. At 308, if the location data corresponds to the address for a particular survey response, the method 300 advances to 310. At 310, if the response time for the responses is greater than a first threshold time and less than a second threshold time, the method 300 may include automatically assigning a relatively high reliability value to the received data based on the correlated location and timing data, at 312.

Returning to 310, if the response time is less than a first threshold or greater than a second threshold, the method 300 may include automatically assigning a relatively low reliability value to the received data based on the correlated location and timing data, at 318. The response time may be too quick (indicating a possible fake or made-up response) or too long (indicating that the survey was not being conducted in real-time or that the results may be unreliable).

Returning to 308, if the location data does not correspond to the address, the method 300 may include automatically assigning a relatively low reliability value to the received data based on the correlated location and timing data, at 318.

Whether the method 300 assigns a relatively high reliability value (at 312) or a relatively low reliability value (at 318), the method 300 includes selectively determining a point value for a user responsible for collection and entry of the received data based on the reliability, at 314. In an example, a particular user may interview a plurality of respondents at different addresses. Some of the survey responses may be deemed reliable based on the location and timing data, while others of the survey responses may be scored as being relatively less reliable. The system may assign an overall score or point value to the user based on the totality of survey responses.

At 316, the method 300 may include selectively associating the point value with the user for determination of pay for the user. In an example, the data verification system 102 may communicate data related to the reliability scores to the HR system 202 for determination of payroll for the particular user. Other embodiments are also possible.

It should be appreciated that the response time and response location (e.g., GPS location) are only two of the many possible criteria that can be used to evaluate the reliability of survey data. In some embodiments, in addition to timing and location data, reliability may be determined, at least in part, by processing audio data associated with a canvasser's portion of a survey conversation and comparing words determined from the audio data against key words of a survey script associated with a survey. If the survey questions are not being asked, the survey results are most likely not reliable. Other criteria (or combinations of criteria) may be used to determine the reliability. Other embodiments are also possible.

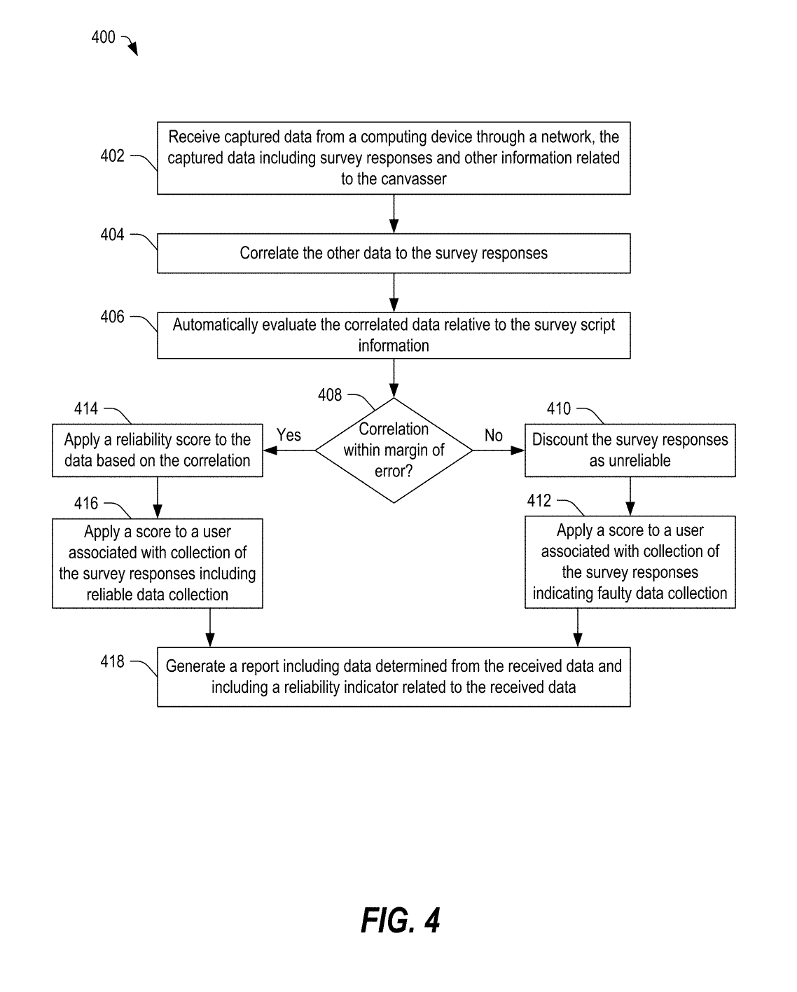

FIG. 4 depicts a block diagram of a method 400 of generating a report based on survey data and including a reliability indicator, in accordance with certain embodiments of the present disclosure. At 402, the method 400 can include receiving captured data from a computing device through a network, where the captured data may include survey responses and other information submitted by the canvasser. In an example, the canvasser may interview respondents based on questions presented within a graphical interface on his or her smartphone or tablet computer and may enter survey responses by interacting with selectable options within the graphical interface (i.e., by interacting with a touchscreen). The other information can include location data where the survey was conducted, and the survey may include particular addresses or locations where the survey questions are to be asked. The other information may include timing data, such as a start time, an end time, timing between each response, other timing data, or any combination thereof, and the survey may include average time information or other information. In some examples, the other information can include keystroke data or audio data captured from a canvasser's portion of a phone survey. Other embodiments are also possible.

At 404, the method 400 may include correlating the other data to the survey responses. The other data may include timing data, location data, keystroke data, and so on. At 406, the method 400 may include automatically evaluating the correlated relative to the survey script information. In an example, the data verification system 102 may be configured to determine whether the user visited the specified location or address and whether the user spent sufficient time at that location to actually conduct and complete the survey. Alternatively, the data verification system 102 may be configured to determine if the canvasser actually asked the survey questions based on audio data. In another example, the data verification system 102 may be configured to detect keystrokes or survey response timing to determine whether the responses are legitimate.

At 408, the method 400 may include determining whether the correlated data is within a margin of error. In an example, the correlated data may be compared to expected timing information, expected location information, or any combination thereof. If the timing information is outside of an expected range or if the location information does not correspond to an expected location, the correlated data may be outside of a margin of error.

If the correlated data is not within the margin of error, the method 400 may include discounting the survey responses as unreliable, at 410. In some embodiments, the unreliable survey responses may be discarded. In other embodiments, a reliability score may be assigned to the survey response, and the reliability score may be used to apply a weighting to the responses for the purpose of determining analytics. Further, in some examples, the reliability score may be used to determine a payroll adjustment associated with the canvasser.

At 412, the method 400 may include applying a score to a user associated with the collection of the survey responses indicating faulty data collection. In an example, a flawless data collection may receive a score of 100, while data collection with some discrepancies may receive a score of 92. Data collection that indicates that the entire survey results data was falsified may be scored at zero. Other scoring techniques or measures may also be used.

At 418, the method 400 can include generating a report including data determined from the received data and including a reliability indicator related to the received data. In some embodiments, the report may include analytics, raw data and associated reliability values, other information, or any combination thereof. The report may be sent as an electronic message, a graphical interface, a text, or another alert that may include survey data, one or more reliability indicators,

Returning to 408, if the correlated data is within a margin of error, the method 400 may include applying a reliability score to the data based on the correlation, at 414. At 416, the method 400 may include applying a score to a user (canvasser) associated with the collection of the survey responses indicating reliable data collection. In some embodiments, each time a canvasser completes a survey, the reliability of the submitted results may be reflected as a score associated with the canvasser, which scores can be aggregated to rate the quality of the canvasser. At 418, the method 400 may include generating a report including data determined from the received data and including a reliability indicator related to the received data.

In the illustrated examples, the methods depicted in FIGS. 3 and 4 include blocks representing steps in a process. However, it should be appreciated that, in some embodiments, the blocks may be combined or omitted or other steps may be added without departing from the scope of the present disclosure.

Further, in the above-examples, the location data is used as a factor in determining the reliability of survey responses. However, in instances where the survey is conducted by telephone, the location data may not be relevant, and the reliability calculations may be based instead on call log information, analysis of audio data from a canvasser's portion of the phone call, other information, or any combination thereof. Other embodiments are also possible.

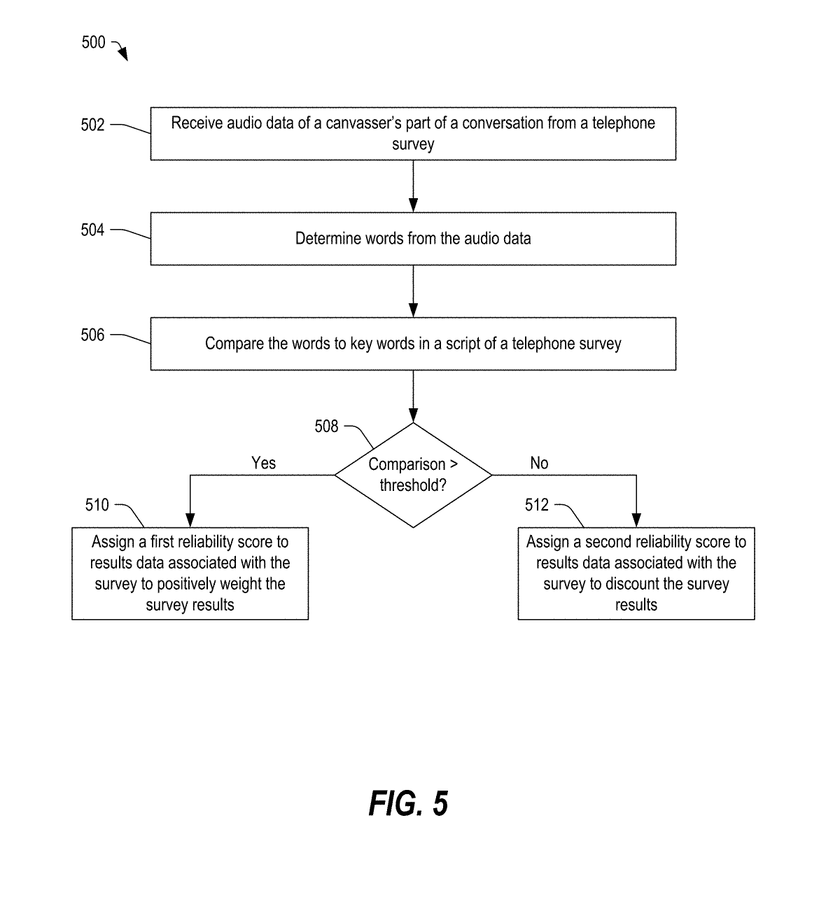

FIG. 5 depicts a block diagram of a method 500 of determining a reliability score for survey data based on audio data of a canvasser's portion of a survey, in accordance with certain embodiments of the present disclosure. At 502, the method 500 may include receiving audio data of a canvasser's portion of a conversation from a telephone survey. In some embodiments, the audio data may be recorded at the user's device during the process of administering the survey. The audio data may be captured by a survey application operating on a computing device 104 associated with a canvasser (using, for example, the microphone of the computing device 104) and may be sent, together with the survey results, to a data verification system. Other embodiments are also possible.

At 504, the method 500 can include determining words from the audio data. In a particular example, raw audio data recorded from the canvasser's portion of the telephone conversation may be processed to determine words. In a particular example, a speech-to-text conversion may be performed to determine text.

At 506, the method 500 may include comparing the determined words to key words in a script of a telephone survey. In an example, the data verification system may compare selected ones of a plurality of determined words to key words identified within the survey questions to determine an extent of the overlap. In particular, the determined words may be compared to the words in the script of the survey to make sure that the canvasser is asking the questions from the survey.

At 508, if the comparison overlap is greater than a threshold overlap, the method 500 may include assigning a first reliability score to results data associated with the survey to positively weight the survey results, at 510. In this example, the overlap may indicate that the canvasser asked the questions from the survey, which may mean that the survey results can be relied upon. Other embodiments are also possible.

Returning to 508, if the comparison overlap is less than a threshold overlap, the method 500 can include assigning a second reliability score to results data associated with the survey to discount the survey results, at 512. In this example, the lower overlap may indicate that the canvasser either didn't ask the survey questions or changed the wording, undermining the reliability of the survey results. Accordingly, the second reliability score may be lower than the first reliability score. Other embodiments are also possible.

In conjunction with the devices, systems, and methods described above with respect to FIGS. 1-5, a system is disclosed that may be configured to compare GPS location data and timing data associated with survey results to location data and standard survey completion timing information to determine the reliability of the survey data. By utilizing the GPS location data, the system can determine whether the user actually visited the address as specified in the survey. Further, by comparing the timing of the data entry to standard survey response timing, the system can determine whether someone is falsifying the responses, in part, because the survey is completed in insufficient time for the user to have asked the questions of another and to have the respondent actually respond. Other embodiments are also possible.

Although the present invention has been described with reference to preferred embodiments, workers skilled in the art will recognize that changes may be made in form and detail without departing from the scope of the invention.

What is claimed is:

1. A computing device comprising:
an interface configured to couple to a network;
a processor coupled to the interface; and
a memory accessible to the processor and configured to store instructions that, when executed, cause the processor to:
receive captured data including survey responses and associated data;
automatically determine a reliability score associated with each of the survey responses from the survey responses and the associated data; and
provide a report to a device via the network, the report including survey results selectively determined from the survey responses based on the reliability scores from each of the survey responses.

2. The computing device of claim 1, wherein the associated data includes location data corresponding to a geophysical location where each survey response was collected.

3. The computing device of claim 2, wherein the memory includes instructions that, when executed, cause the processor to compare the location data of a survey response to at least one address specified by a survey to determine whether the survey responses correspond to the at least one address.

4. The computing device of claim 1, wherein the associated data includes audio data of a canavasser's voice captured during a survey.

5. The computing device of claim 4, wherein the memory further includes instructions that, when executed, cause the processor to analyze the audio data to determine one or more words and to compare the one or more words to words of a script of the survey and to determine the reliability score based on overlap between the one or more words and the words of the script.

6. The computing device of claim 1, wherein the associated data includes timing data associated with timing of when each survey response was captured and includes location data associated with a geophysical location where the survey response was collected.

7. The computing device of claim 6, wherein the memory further includes instructions that, when executed, cause the processor to:
correlate the timing data and the location data to each survey response;
determine a time difference between capture of a first survey response at a first location and capture of a second survey response at a second location based on the timing data;
determine an estimated travel time between a first location associated with a first survey response and a second location associated with a second survey response; and
determine the second survey response is unreliable when a difference between the estimated travel time and the time difference is greater than a threshold time.

8. A method comprising:
receiving, at a server through a network, first survey data and first associated data from a computing device;
receiving, at the server through the network, second survey data and second associated data from the computing device;
automatically determining, using the server, a first reliability value associated with the first survey data based on the first associated data; and
automatically determining, using the server, a second reliability value associated with the second survey data based on the second associated data;
automatically generating, using the server, a report including data related to the first survey data and the second survey data and including the first reliability value and the second reliability value; and
automatically sending the report from the server to a device through the network.

9. The method of claim 8, wherein the first survey data and the second survey data include data associated with a common survey.

10. The method of claim 8, wherein the associated data includes at least one of location data corresponding to a geophysical location where each survey response was collected, timing data corresponding to a timing when each survey response was collected, audio data of a canvasser's voice captured during a survey, and keystroke data captured with each survey response.

11. The method of claim 10, further comprising comparing, at the server, the location data of a survey response to at least one address specified by a survey to determine whether the survey responses correspond to the at least one address.

12. The method of claim 10, further comprising:
analyzing, at the server, the audio data to determine one or more words;
comparing the one or more words to words of a script of the survey; and
determining the reliability score based on overlap between the one or more words and the words of the script.

13. The method of claim 10, further comprising:
automatically correlating the timing data and the location data to each survey response;
automatically determining a time difference between capture of a first survey response at a first location and capture of a second survey response at a second location based on the timing data;
automatically determining an estimated travel time between a first location associated with a first survey response and a second location associated with a second survey response; and
automatically determining the second survey response is unreliable when a difference between the estimated travel time and the time difference is greater than a threshold time.

14. A system comprising:
an interface configured to communicate with a communications network;
a processor coupled to the interface; and
a memory accessible to the processor and configured to store instructions that, when executed, may cause the processor to:
receive survey data and associated data from a plurality of computing devices through the communications network, each computing device is associated with a particular canvasser;
process the survey data to determine reliability of the survey data based on the associated data; and
communicate survey results including a reliability indicator based on the determined reliability and the survey data to a device through the communications network.

15. The system of claim 14, wherein the memory further includes instructions that, when executed, cause the processor to update a human resources system based on the reliability indicator.

16. The system of claim 14, wherein the associated data includes:
location data from a global positioning satellite (GPS) circuit of each computing device of the plurality of computing devices; and
timing data determined by a processor of each computing device of the plurality of computing devices.

17. The system of claim 16, wherein the memory includes instructions that, when executed, cause the processor to compare the location data of a survey response to at least one address specified by a survey to determine whether the survey responses correspond to the at least one address.

18. The system of claim 16, wherein the memory further includes instructions that, when executed, cause the processor to:
correlate the timing data and the location data to each survey response;
determine a time difference between capture of a first survey response at a first location and capture of a second survey response at a second location based on the timing data;
determine an estimated travel time between a first location associated with a first survey response and a second location associated with a second survey response; and
determine the second survey response is unreliable when a difference between the estimated travel time and the time difference is greater than a threshold time.

19. The system of claim 14, wherein the associated data includes audio data of a canavasser's voice captured during a survey by a microphone of each of the computing devices.

20. The system of claim 19, wherein the memory further includes instructions that, when executed, cause the processor to analyze the audio data to determine one or more words and to compare the one or more words to words of a script of the survey and to determine the reliability score based on overlap between the one or more words and the words of the script.
